(19) United States
(12) Patent Application Publication
(10) Pub. No.: US 2016/0069251 A1
(43) Pub. Date: Mar. 10, 2016

(54) PRESSURE-LIMITING DEVICE FOR PRE-COMBUSTION CHAMBER

(71) Applicant: Caterpillar Inc., Peoria, IL (US)

(72) Inventor: Andrew J. Loetz, West Lafayette, IN (US)

(73) Assignee: Caterpillar Inc., Peoria, IL (US)

(21) Appl. No.: 14/940,179

(22) Filed: Nov. 13, 2015

(51) Int. Cl. F02B 19/18

(52) U.S. Cl. CPC F02B 19/18

(57) ABSTRACT

An engine with a main combustion chamber and a pre-combustion chamber assembly is provided. The pre-combustion chamber assembly includes a pre-combustion chamber, a pressure-limiting device, and a fluid conduit. The pressure-limiting device includes a first end and a second end. The first end includes a spring. The second end is exposed to the pre-combustion chamber. The pressure-limiting device is operable in a passive state and an active state. The fluid conduit is disposed between the main combustion chamber and the first end of the pressure-limiting device to facilitate fluid communication between the main combustion chamber and the pressure-limiting device. The pressure-limiting device is actuated to the active state when fluid pressure in the pre-combustion chamber reaches a threshold value during pre-chamber combustion. In the active state, the pressure-limiting device moves away from the pre-combustion chamber, to increase a volume in the pre-combustion chamber.

### TECHNICAL FIELD

The present disclosure relates to pre-combustion chamber in an internal combustion engines. More particularly, the present disclosure relates to a pressure-limiting device to limit peak pressure in the pre-combustion chamber.

### BACKGROUND

Internal combustion engines (ICE) are commonly known to employ a number of combustion cylinders, where an air-fuel mixture is burnt to produce power required to run a machine. In some internal combustion engine applications, such as gaseous fuel applications, a combustion system includes a pre-combustion chamber in addition to a main combustion cylinder. Typically, the pre-combustion chamber is located in a cylinder head and is in fluid communication with the main combustion chamber of the engine via a number of small orifices. During operation, the pre-combustion chamber is adapted to receive an air-fuel mixture which is ignited by a spark plug located within the pre-combustion chamber Ignition of the air-fuel mixture in the pre-combustion chamber creates a flame of burning fuel which is jetted or otherwise advanced through the orifices into the main combustion chamber, thereby igniting an air-fuel mixture therein.

As is customarily known, NOx gases are produced during ignition of the air-fuel mixture in the main combustion chamber. In addition, due to pre-combustion of the air-fuel mixture in the pre-combustion chamber, high peak pressures arise in the pre-combustion chamber. Due to such peak pressures there is high NOx formation in the pre-combustion chamber. Hence, total NOx formation in the engines increases due to higher NOx formations in the pre-combustion chamber. Therefore there is a need to control the peak pressure to minimize the NOx formation in the pre-combustion chamber.

U.S. Pat. No. 7,100,567 discloses a pre-chamber piston to vary volume within a pre-chamber during a portion of a compression stroke of a main combustion chamber. The pre-chamber piston may be mechanically, hydraulically, electrically, or pneumatically actuated. However, the '567 reference discloses the pre-chamber piston which is controlled by a controller. This arrangement is expensive and employs a plurality of sensors.

The present disclosure is directed towards one or more above-mentioned problems.

### SUMMARY OF THE INVENTION

Various aspects of the present disclosure describe an engine with a main combustion chamber and a pre-combustion chamber assembly. The pre-combustion chamber assembly is disposed proximal to the main combustion chamber. The pre-combustion chamber assembly includes a pre-combustion chamber, a pressure-limiting device, and a fluid conduit. The pressure-limiting device includes a first end and a second end. The pressure-limiting device is disposed along a longitudinal axis, such that the second end is exposed to the pre-combustion chamber. The first end includes a spring. The pressure-limiting device is operable in a passive state and an active state. The fluid conduit is disposed between the main combustion chamber and the first end of the pressure-limiting device to facilitate fluid communication between the main combustion chamber and the pressure-limiting device. The pressure-limiting device is actuated to the active state when fluid pressure in the pre-combustion chamber reaches a threshold value during pre-chamber combustion. In the active state, the pressure-limiting device moves away from the pre-combustion chamber via compression of the spring, to increase a volume in the pre-combustion chamber.

### BRIEF DESCRIPTION OF THE DRAWINGS

FIG. 1 is a sectional view of a portion of an engine showing a pre-combustion chamber assembly and a main combustion chamber, in accordance with the concepts of the present disclosure.

### DETAILED DESCRIPTION

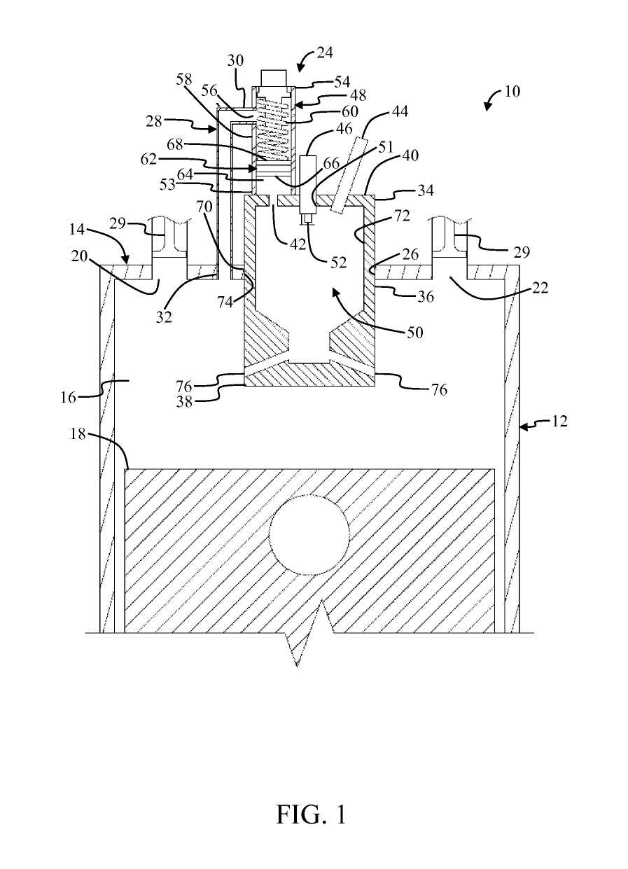

Referring to FIG. 1, there is shown a partial sectional view of an engine 10. The engine 10 includes a cylinder 12 and a cylinder head 14. The cylinder 12 includes a main combustion chamber 16 and a piston 18. The piston 18 is slidably disposed within the cylinder 12 to reciprocate between a top-dead-center position and a bottom-dead-center position. The main combustion chamber 16 accommodates air-fuel mixture, which is ignited to produce power.

The cylinder head 14 is engaged with an engine block (not shown) to cover the cylinder 12 and define the main combustion chamber 16 of the cylinder 12. The cylinder head 14 includes an intake opening 20, an exhaust opening 22, a pre-combustion chamber assembly 24, a bore 26, and a fluid conduit 28. The intake opening 20 allows intake gases into the main combustion chamber 16. The exhaust opening 22 allows exhaust gases out of the main combustion chamber 16. Engine valves 29 are positioned to selectively open and close the intake opening 20 and the exhaust opening 22.

The bore 26 is disposed in the cylinder head 14 between the engine valves 29. The bore 26 opens into the main combustion chamber 16. The bore 26 is structured to accommodate the pre-combustion chamber assembly 24.

The fluid conduit 28 is disposed in the cylinder head 14. The fluid conduit 28 extends between the main combustion chamber 16 and the pre-combustion chamber assembly 24. The fluid conduit 28 includes a first end 30 and a second end 32. The first end 30 is disposed in the cylinder head 14 proximal to the main combustion chamber 16 such that the first end 30 is exposed to the main combustion chamber 16. The first end 30 is in fluid communication with main combustion chamber 16. The second end 32 is disposed in the pre-combustion chamber assembly 24.

The pre-combustion chamber assembly 24 is shown disposed in the bore 26 in the cylinder head 14. The pre-combustion chamber assembly 24 extends from the cylinder head 14 into the main combustion chamber 16. The pre-combustion chamber assembly 24 may be configured in a variety of ways. An assembly capable of being positioned in the cylinder head 14 to support a combustion event outside of the main combustion chamber 16, and direct the combustion into the main combustion chamber 16 may be used.

The pre-combustion chamber assembly 24 includes a top portion 34, a neck portion 36, and a tip portion 38. The top portion 34 may be coupled to the cylinder head 14 via fasteners (not shown). The top portion 34 includes a top wall 40. The top portion 34 includes a port 42, a fuel admission valve 44, a spark plug 46, and a pressure-limiting device 48.

The fuel admission valve 44 is adapted for delivery of fuel to a pre-combustion chamber 50, which is disposed in the tip portion 38. The fuel admission valve 44 is in fluid communication with the pre-combustion chamber 50. The fuel admission valve 44 is adapted to pass fuel, such as gaseous fuel, into the pre-combustion chamber 50.

The top wall 40 includes a threaded bore 51. The threaded bore 51 extends through the top wall 40 and is adapted to receive the spark plug 46. The spark plug 46 is positioned in a way such that a spark plug tip 52 extends in the pre-combustion chamber 50. The spark plug 46 in the context of this disclosure means a suitable ignition device available in the art.

The pressure-limiting device 48 is secured on the top wall 40 such that the pressure-limiting device 48 is fluidly connected to the port 42. The pressure-limiting device 48 includes a first end 53 and a second end 54. The first end 53 is attached onto the top wall 40 and is proximal to the port 42. The port 42 allows fluid communication between the pressure-limiting device 48 and the pre-combustion chamber 50. The second end 54 is exposed and proximal to the second end 32 of the fluid conduit 28. The second end 54 includes an inlet 56, which allows fluid communication between the pressure-limiting device 48 and the main combustion chamber 16.

The pressure-limiting device 48 includes an accumulator body 58, a spring 60, and an accumulator piston 62. The accumulator body 58 defines an accumulator volume 64, which accommodates the spring 60 and the accumulator piston 62. The spring 60 acts on the accumulator piston 62. The accumulator piston 62 includes a first side 66 directed towards the first end 53 and a second side 68 directed towards the second end 54. The accumulator piston 62 is movable between the first end 53 and the second end 54, depending on a pressure difference of fluid pressures acting on the first side 66 and the second side 68 of the accumulator piston 62. The pressure difference is difference in fluid pressures of the main combustion chamber 16 and the pre-combustion chamber 50. The fluid pressure of the main combustion chamber 16 is communicated to the pressure-limiting device 48 via the inlet 56. The fluid pressure of the main combustion chamber 16 acts on the second side 68 of the accumulator piston 62. The fluid pressure of the pre-combustion chamber 50 is communicated to the pressure-limiting device 48 via the port 42. The fluid pressure of the pre-combustion chamber 50 acts on the first side 66 of the accumulator piston 62.

The pressure-limiting device 48 is operable in a passive state and an active state. The pressure-limiting device 48 is actuated to the active state when the fluid pressure in the pre-combustion chamber 50 reaches a threshold value during a pre-chamber combustion. In the active state, the accumulator piston 62 moves away from the pre-combustion chamber 50 via compression of the spring 60, thereby increasing a volume in the pre-combustion chamber 50. In the passive state, the accumulator piston 62 is maintained at a pre-determined position, when the fluid pressure in the pre-combustion chamber 50 is below the threshold value.

The neck portion 36 is received in the bore 26. The bore 26 allows some portion of the neck portion 36 and complete tip portion 38 to extend into and be exposed to the main combustion chamber 16. The neck portion 36 includes a first sealing surface 70 and an inner periphery 72. The first sealing surface 70 is disposed about the neck portion 36 at a predetermined location. The first sealing surface 70 is provided to seal against a second sealing surface 74 provided in the cylinder head 14. The second sealing surface 74 is located in the bore 26.

The inner periphery 72 is defined between the top wall 40 and the tip portion 38. The inner periphery 72 along with the top wall 40 and the tip portion 38 defines the pre-combustion chamber 50.

The tip portion 38 includes a number of spaced apart, radially oriented orifices 76. The orifices 76 open into the pre-combustion chamber 50 and into the main combustion chamber 16. The orifices 76 direct the expanding gases from the pre-combustion chamber 50 in a predetermined pattern into the main combustion chamber 16.

### INDUSTRIAL APPLICABILITY

With reference to the drawing, and in operation, the pre-combustion chamber assembly 24 may be installed in the cylinder head 14. A fuel system (not shown) may supply a mixture of gaseous fuel and air to the pre-combustion chamber 50 via the fuel admission valve 44. The spark plug 46 mounted to the pre-combustion chamber assembly 24 ignites the mixture of gaseous fuel and air within the pre-combustion chamber 50. After combustion of the mixture of gaseous fuel and air within the pre-combustion chamber 50, the burning fuel, for example, in the shape of torches may be emitted into the main combustion chamber 16 via the orifices 76. There, the burning fuel may initiate the main combustion process and may ignite a mixture of gaseous fuel and air within the main combustion chamber 16 supplied by the intake opening 20.

Prior to pre-chamber combustion, the fluid pressure in the pre-combustion chamber 50 is below the threshold value and the fluid pressure in the main combustion chamber 16 is equal to a first pressure. The fluid pressure of the pre-combustion chamber 50 is communicated to the first side 66 of the accumulator piston 62 via the port 42. The first pressure is communicated to the second side 68 of the accumulator piston 62, via the fluid conduit 28. In this case, the fluid pressures acting on the sides 66 and 68 of the accumulator piston 62 of the pressure-limiting device 48 are such that the accumulator piston 62 is maintained in the passive state. During the pre-chamber combustion, the fluid pressure in the pre-combustion chamber 50 increases and reaches the threshold value. This fluid pressure is communicated to the first side 66 of the accumulator piston 62. The second side 68 of the accumulator piston 62 is exposed to the first pressure. Since, the fluid pressure in the pre-combustion chamber 50 is greater than the first pressure, thus, the fluid pressure acting on the first side 66 is greater than the fluid pressure acting on the second side 68. The accumulator piston 62 moves away from the first end 30, thereby increasing the volume of the pre-combustion chamber 50. This results in reduction of temperature in the pre-combustion chamber 50 and hence, reduction of NOx formation. This aids to increase pre-chamber jet duration to extend lean misfire in the main combustion chamber 16. Further, upon reaching an exhaust stroke, pressure in the main combustion chamber 16 decreases. This relieves the pressure on the spring 60 and hence, the accumulator piston 62 is restored to the passive state.

The many features and advantages of the disclosure are apparent from the detailed specification, and thus, it is intended by the appended claims to cover all such features and advantages of the disclosure that fall within the true spirit and scope thereof. Further, since numerous modifications and variations will readily occur to the one skilled in the art. It is not desired to limit the disclosure to the exact construction and operation illustrated and described, and, accordingly, all suitable modifications and equivalents may be resorted to that fall within the scope of the disclosure.

What is claimed is:

1. An engine, comprising:
a main combustion chamber;
a pre-combustion chamber assembly disposed proximal to the main combustion chamber, the pre-combustion chamber assembly including:
a pre-combustion chamber;
a pressure-limiting device including a first end and a second end, the pressure-limiting device disposed along a longitudinal axis, such that the second end is exposed to the pre-combustion chamber, the first end including a spring, wherein the pressure-limiting device being operable in a passive state and an active state;
a fluid conduit disposed between the main combustion chamber and the first end of the pressure-limiting device to facilitate fluid communication between the main combustion chamber and the pressure-limiting device;
wherein the pressure-limiting device being actuated to the active state when a fluid pressure in the pre-combustion chamber reaches a threshold value during a pre-chamber combustion,
wherein in the active state the pressure-limiting device moves away from the pre-combustion chamber via compression of the spring, thereby increasing a volume in the pre-combustion chamber.
